(19) United States
(12) Patent Application Publication
(10) Pub. No.: US 2017/0273091 A1
(43) Pub. Date: Sep. 21, 2017

(54) METHOD AND DEVICE FOR RECEIVING SIGNAL IN WIRELESS ACCESS SYSTEM SUPPORTING FDR TRANSMISSION

(71) Applicant: LG ELECTRONICS INC., Seoul (KR)

(72) Inventors: Kwangseok NOH, Seoul (KR); Jaehoon CHUNG, Seoul (KR); Genebeck HAHN, Seoul (KR); Eunjong LEE, Seoul (KR); Jinmin KIM, Seoul (KR); Kukheon CHOI, Seoul (KR)

(21) Appl. No.: 15/310,275

(22) PCT Filed: May 11, 2015
(86) PCT No.: PCT/KR2015/004681

§ 371 Date: Nov. 10, 2016

Related U.S. Application Data
(60) Provisional application No. 61/991,595, filed on May 11, 2014.

(51) Int. Cl. H04W 72/08; H04L 5/14; H04W 72/12; H04W 24/08

(52) U.S. Cl. CPC H04W 72/082; H04W 24/08; H04L 5/14; H04W 72/121

(57) ABSTRACT

The present invention relates to a wireless access system supporting a full duplex radio (FDR) transmission environment. The method for a terminal to receive a signal in a wireless access system supporting an FDR, according to an embodiment of the present invention, comprises the steps of: measuring the inter-terminal interference between the terminal and candidate terminals; establishing a group of the terminal and a candidate terminal that has been selected due to the measured inter-terminal interference value; transmitting group information of the group to a base station; and receiving a signal by using resources allocated on the basis of the group information.

### TECHNICAL FIELD

The present invention relates to a wireless access system supporting a full duplex radio (FUR) transmission environment, and more particularly, to a resource allocation method for efficiently receiving a signal when FDR is applied and device for supporting the same.

### BACKGROUND ART

Wireless communication systems are widely deployed to provide various kinds of communication content such as voice and data. Generally, these communication systems are multiple access systems capable of supporting communication with multiple users by sharing available system resources (e.g., bandwidth and transmit power). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency-division multiple access (SC-FDMA) system.

### DISCLOSURE OF THE INVENTION

### Technical Task

One object of the present invention is to provide resource allocation methods for efficiently transmitting and receiving data in a wireless access system supporting FDR transmission.

Another object of the present invention is to provide devices for supporting the above methods.

The technical objects that can be achieved through the present invention are not limited to what has been particularly described hereinabove and other technical objects not described herein will be more clearly understood by persons skilled in the art from the following detailed description.

Technical Solutions

### DESCRIPTION OF DRAWINGS

FIG. 1 illustrates a structure of a radio frame used in the 3GPP LTE system.

FIG. 2 illustrates examples of frame configurations of the radio frame structure in FIG. 1

FIG. 3 is a diagram for a structure of a downlink subframe.

FIG. 4 is a diagram for a structure of an uplink subframe.

FIG. 5 is a diagram illustrating a configuration of a wireless communication system supporting multiple antennas.

FIG. 6 is a diagram illustrating exemplary CRS and DRS patterns for one resource block.

FIG. 7 is a diagram illustrating an example of a DM RS pattern defined in the LTE-A system.

FIG. 8 is a diagram illustrating examples of a CSI-RS pattern defined in the LTE-A system.

FIG. 9 is a diagram illustrating an example of a zero-power (ZP) CSI-RS pattern defined in the LTE-A system.

FIG. 10 illustrates an example of a system supporting FDR.

FIG. 11 illustrates an example of inter-device interference.

FIG. 12 illustrates FDMA and TDMA operations when a BS operates in FD (full duplex) mode on the same resource and UEs perform multiple access.

FIG. 13 is a flowchart for explaining an initial grouping configuration method according to a first embodiment of the present invention.

FIG. 14 illustrates an example of assigning bits indicating whether a UE participates in a grouping.

FIG. 15 illustrates deployment of an eNB and UEs and group configurations for a UE-specific grouping.

FIG. 16 illustrates examples of measured IDI values.

FIG. 17 illustrates an example of grouping individual UEs based on thresholds.

FIG. 18 is a flowchart for explaining grouping update according to a second embodiment of the present invention.

FIG. 19 illustrates an example of grasping a grouping candidate based on a grouping participation request and whether the grouping candidate belongs to a group.

FIG. 20 illustrates an example of allocating frequency for IDI measurement to grouping candidate UEs.

FIG. 21 illustrates examples in which UEs operate in FD mode on the same resources.

FIG. 22 illustrates an eNB and a UE applicable to an embodiment of the present invention.

### BEST MODE FOR INVENTION

The embodiments described below are constructed by combining elements and features of the present invention in a predetermined form. The elements or features may be considered selective unless explicitly mentioned otherwise. Each of the elements or features can be implemented without being combined with other elements. In addition, some elements and/or features may be combined to configure an embodiment of the present invention. The sequence of the operations discussed in the embodiments of the present invention may be changed. Some elements or features of one embodiment may also be included in another embodiment, or may be replaced by corresponding elements or features of another embodiment.

Embodiments of the present invention will be described, focusing on a data communication relationship between a base station and a terminal. The base station serves as a terminal node of a network over which the base station directly communicates with the terminal. Specific operations illustrated as being conducted by the base station in this specification may also be conducted by an upper node of the base station, as necessary.

In other words, it will be obvious that various operations allowing for communication with the terminal in a network composed of several network nodes including the base station can be conducted by the base station or network nodes other than the base station. The term “base station (BS)” may be replaced with terms such as “fixed station,” “Node-B,” “eNode-B (eNB),” and “access point”. The term “relay” may be replaced with such terms as “relay node (RN)” and “relay station (RS)”. The term “terminal” may also be replaced with such terms as “user equipment (UE),” “a mobile station (MS),” “mobile subscriber station (MSS)” and “subscriber station (SS)”.

It should be noted that specific terms disclosed in the present invention are proposed for convenience of description and better understanding of the present invention, and these specific terms may be changed to other formats within the technical scope or spirit of the present invention.

In some cases, known structures and devices may be omitted or block diagrams illustrating only key functions of the structures and devices may be provided, so as not to obscure the concept of the present invention. The same reference numbers will be used throughout this specification to refer to the same or like parts.

Exemplary embodiments of the present invention are supported by standard documents disclosed for at least one of wireless access systems including an institute of electrical and electronics engineers (IEEE) 802 system, a 3rd generation partnership project (3GPP) system, a 3GPP long term evolution (LTE) system, an LTE-advanced (LTE-A) system, and a 3GPP2 system. In particular, steps or parts, which are not described in the embodiments of the present invention to prevent obscuring the technical spirit of the present invention, may be supported by the above documents. All terms used herein may be supported by the above-mentioned documents.

The embodiments of the present invention described below can be applied to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be embodied through wireless technologies such as universal terrestrial radio access (UTRA) or CDMA2000. TDMA may be embodied through wireless technologies such as global system for mobile communication (GSM)/general packet radio service (GPRS)/enhanced data rates for GSM evolution (EDGE). OFDMA may be embodied through wireless technologies such as IEEE 802.11 (Wi-Fi), IEEE 802.16 (WiMAX), IEEE 802-20, and evolved UTRA (E-UTRA). UTRA is a part of universal mobile telecommunications system (UMTS). 3rd generation partnership project (3GPP) long term evolution (LTE) is a part of evolved UMTS (E-UMTS), which uses E-UTRA. 3GPP LTE employs OFDMA for downlink and employs SC-FDMA for uplink. LTE-Advanced (LTE-A) is an evolved version of 3GPP LTE. WiMAX can be explained by IEEE 802.16e (wirelessMAN-OFDMA reference system) and advanced IEEE 802.16m (wirelessMAN-OFDMA advanced system). For clarity, the following description focuses on 3GPP LTE and 3GPP LTE-A systems. However, the spirit of the present invention is not limited thereto.

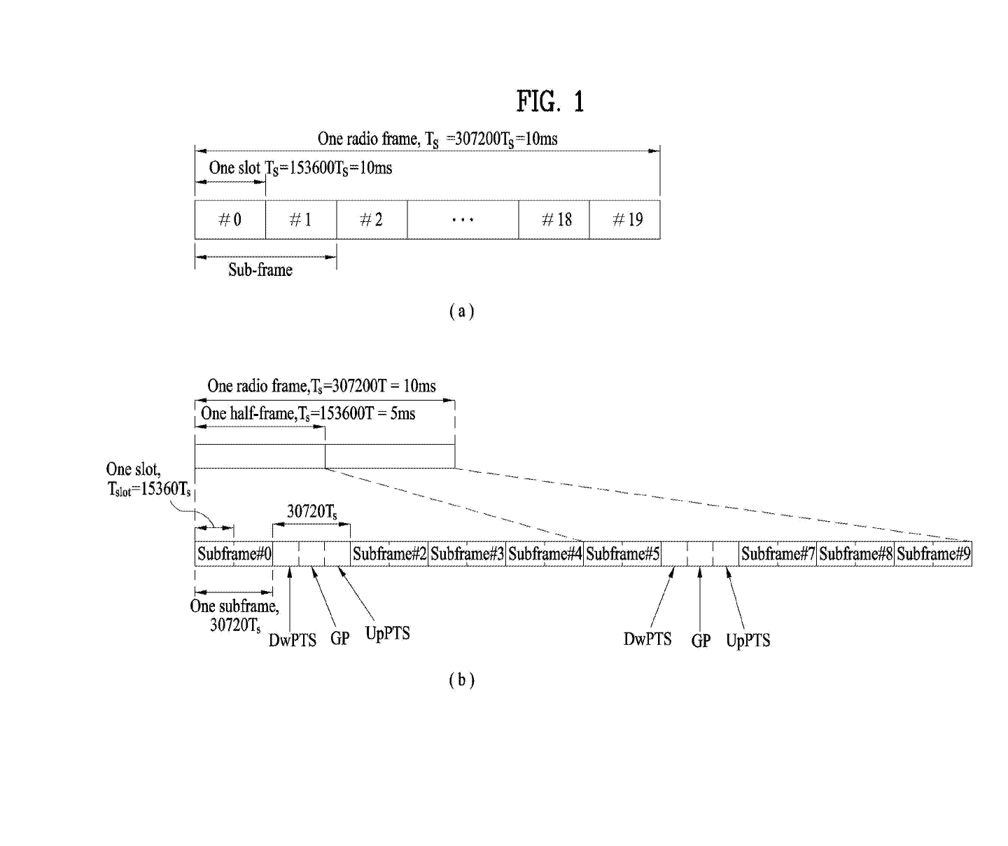

FIG. 1 illustrates a structure of a radio frame used in the 3GPP LTE system.

FIG. 1 illustrates frame structure type 2. The frame structure type 2 is applied to a time division duplex (TDD) system. One radio frame has a length of 10 ms (i.e., T_{f}=307200·Tₛ), including two half-frames each having a length of 5 ms (i.e., 153600·Tₛ). Each half-frame includes five subframes each having a length of 1 ms (i.e., 30720·Tₛ). An i^{th} subframe includes (2i)^{th} and (2i+1)^{th} slots each having a length of 0.5 ms (i.e., Tₛₗₒₜ=15360·Tₛ) where Tₛ is a sampling time given as Tₛ=1/(15 kHz×2048)=3.2552×10⁻⁸ (i.e., about 33 ns).

A type-2 frame includes a special subframe having three fields of downlink pilot time slot (DwPTS), guard period (GP), and uplink pilot time slot (UpPTS). The DwPTS is used for initial cell search, synchronization, or channel estimation at a UE and the UpPTS is used for channel estimation and UL transmission synchronization with a UE at an eNB. The GP is used to cancel UL interference between UL and DL, caused by the multi-path delay of a DL signal. The DwPTS, GP and UpPTS is included in the special subframe of Table 1.

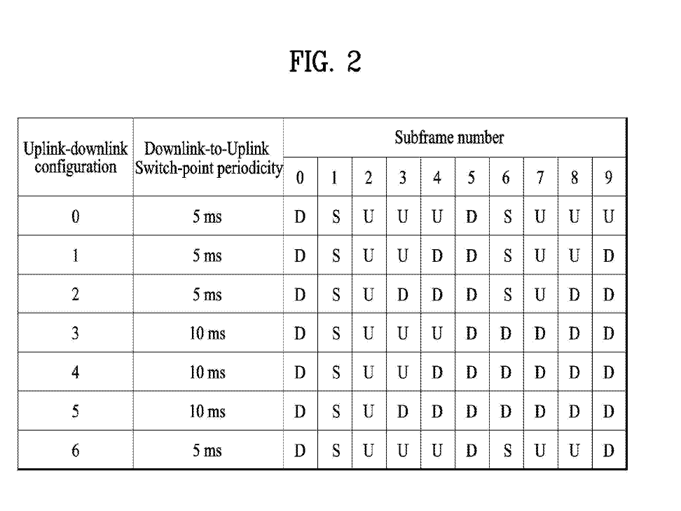

FIG. 2 illustrates examples of frame configurations of the radio frame structure in FIG. 1.

In FIG. 2, ‘D’ represents a subframe for DL transmission, ‘U’ represents a subframe for UL transmission, and ‘S’ represents a special subframe for a guard time.

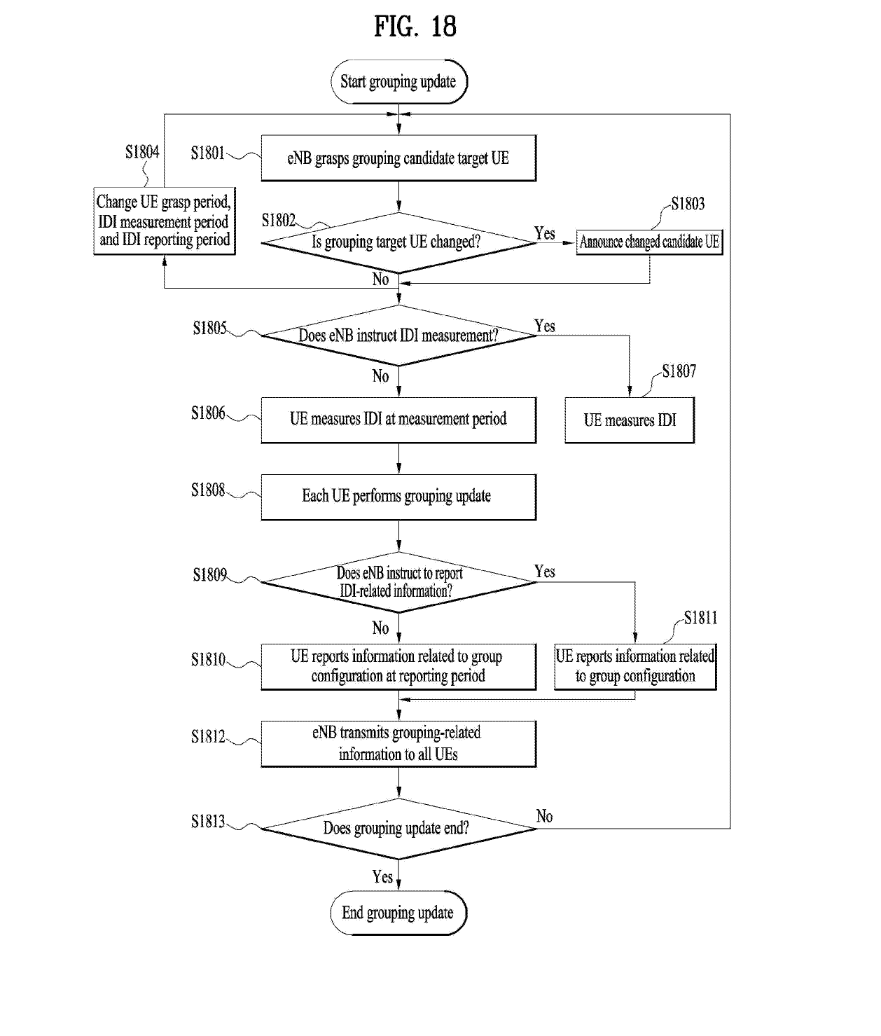

All UEs in each cell have one common frame configuration among the configurations shown in FIG. 18. That is, since a frame configuration is changed depending on a cell, the frame configuration may be referred to as a cell-specific configuration.

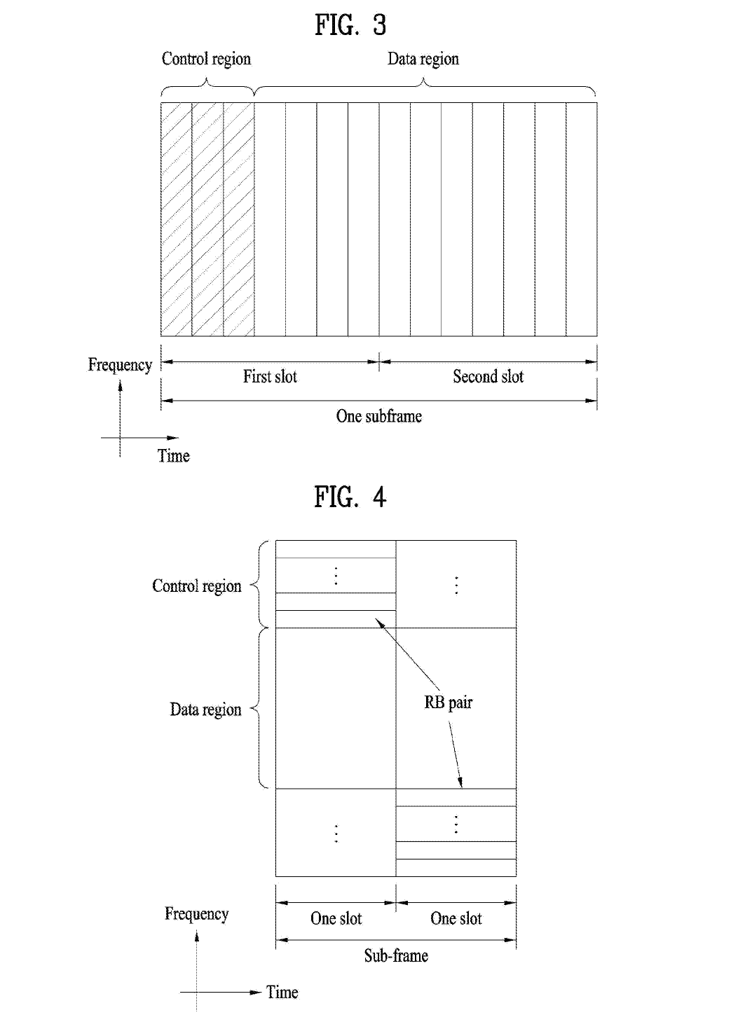

FIG. 3 illustrates a DL subframe structure. Up to the first three OFDM symbols of the first slot in a DL subframe used as a control region to which control channels are allocated and the other OFDM symbols of the DL subframe are used as a data region to which a PDSCH is allocated. DL control channels used in 3GPP LTE include, for example, a physical control format indicator channel (PCFICH), a physical downlink control channel (PDCCH), and a physical hybrid automatic repeat request (HARQ) indicator channel (PHICH). The PCFICH is transmitted at the first OFDM symbol of a subframe, carrying information about the number of OFDM symbols used for transmission of control channels in the subframe. The PHICH carries a HARQ ACK/NACK signal in response to uplink transmission. Control information carried on the PDCCH is called downlink control information (DCI). The DCI includes UL or DL scheduling information or UL transmission power control commands for UE groups. The PDCCH delivers information about resource allocation and a transport format for a DL shared channel (DL-SCH), resource allocation information about an UL shared channel (UL-SCH), paging information of a paging channel (PCH), system information on the DL-SCH, information about resource allocation for a higher-layer control message such as a random access response transmitted on the PDSCH, a set of transmission power control commands for individual UEs of a UE group, transmission power control information, and voice over internet protocol (VoIP) activation information. A plurality of PDCCHs may be transmitted in the control region. A UE may monitor a plurality of PDCCHs. A PDCCH is formed by aggregating one or more consecutive control channel elements (CCEs). A CCE is a logical allocation unit used to provide a PDCCH at a coding rate based on the state of a radio channel. A CCE corresponds to a plurality of RE groups. The format of a PDCCH and the number of available bits for the PDCCH are determined depending on the correlation between the number of CCEs and a coding rate provided by the CCEs. An eNB determines the PDCCH format according to DCI transmitted to a UE and adds a cyclic redundancy check (CRC) to the control information. The CRC is masked by an identifier (ID) known as a radio network temporary identifier (RNTI) according to the owner or usage of the PDCCH. If the PDCCH is directed to a specific UE, its CRC may be masked by a cell-RNTI (C-RNTI) of the UE. If the PDCCH is for a paging message, the CRC of the PDCCH may be masked by a paging indicator identifier (P-RNTI). If the PDCCH delivers system information, particularly, a system information block (SIB), the CRC thereof may be masked by a system information ID and a system information RNTI (SI-RNTI). To indicate that the PDCCH delivers a random access response in response to a random access preamble transmitted by a UE, the CRC thereof may be masked by a random access-RNTI (RA-RNTI).

FIG. 4 illustrates a UL subframe structure. A UL subframe may be divided into a control region and a data region in the frequency domain. A physical uplink control channel (PUCCH) carrying uplink control information is allocated to the control region and a physical uplink shared channel (PUSCH) carrying user data is allocated to the data region. To maintain single carrier property, a UE does not simultaneously transmit a PUSCH and a PUCCH. A PUCCH for a UE is allocated to an RB pair in a subframe. The RBs of the RB pair occupy different subcarriers in two slots. This is often called frequency hopping of the RB pair allocated to the PUCCH over a slot boundary.

Modeling of Multiple Input Multiple Output (MIMO) System

An MIMO system improves data transmission/reception efficiency using multiple transmit antennas and multiple receive antennas. According to the MIMO technology, entire data can be received by combining a plurality of pieces of data received through a plurality of antennas instead of using a single antenna path to receive a whole message.

The MIMO technology can be classified into a spatial diversity scheme and a spatial multiplexing scheme. Since the spatial diversity scheme increases transmission reliability or a cell radius through a diversity gain, it is suitable for data transmission at a fast moving UE. According to the spatial multiplexing scheme, different data are simultaneously transmitted and thus a high data transfer rate can be achieved without increasing a system bandwidth.

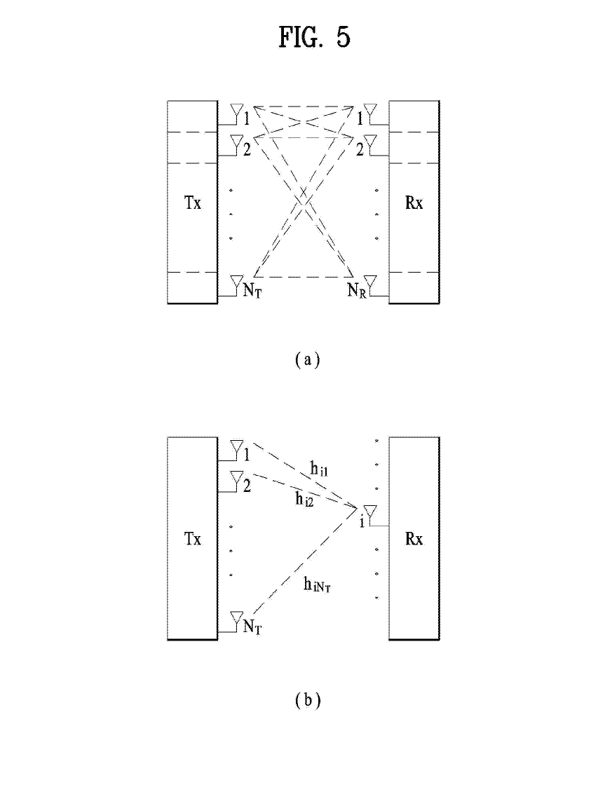

FIG. 5 is a diagram illustrating a configuration of a wireless communication system having multiple antennas. As shown in FIG. 5(a), if the number of transmit antennas is increased to N_{T} and the number of receive antennas is increased to N_{R}, a theoretical channel transmission capacity is increased in proportion to the number of antennas, unlike the case where a plurality of antennas is used in only a transmitter or a receiver. Accordingly, it is possible to improve a transfer rate and to remarkably improve frequency efficiency. As the channel transmission capacity is increased, the transfer rate may be theoretically increased by a product of a maximum transfer rate R₀ upon utilization of a single antenna and a rate increase ratio Rᵢ.

Rᵢ=min(N_{T},N_{R}) [Equation 1]

For instance, in an MIMO communication system, which uses 4 transmitting antennas and 4 receiving antennas, it may be able to obtain a transmission rate 4 times higher than that of a single antenna system. After this theoretical capacity increase of the MIMO system has been proved in the middle of 90's, many ongoing efforts are made to various techniques to substantially improve a data transmission rate. And, these techniques are already adopted in part as standards for the 3G mobile communications and various wireless communications such as a next generation wireless LAN and the like.

The trends for the MIMO relevant studies are explained as follows. First of all, many ongoing efforts are made in various aspects to develop and research information theory study relevant to MIMO communication capacity calculations and the like in various channel configurations and multiple access environments, radio channel measurement and model derivation study for MIMO systems, spatiotemporal signal processing technique study for transmission reliability enhancement and transmission rate improvement and the like.

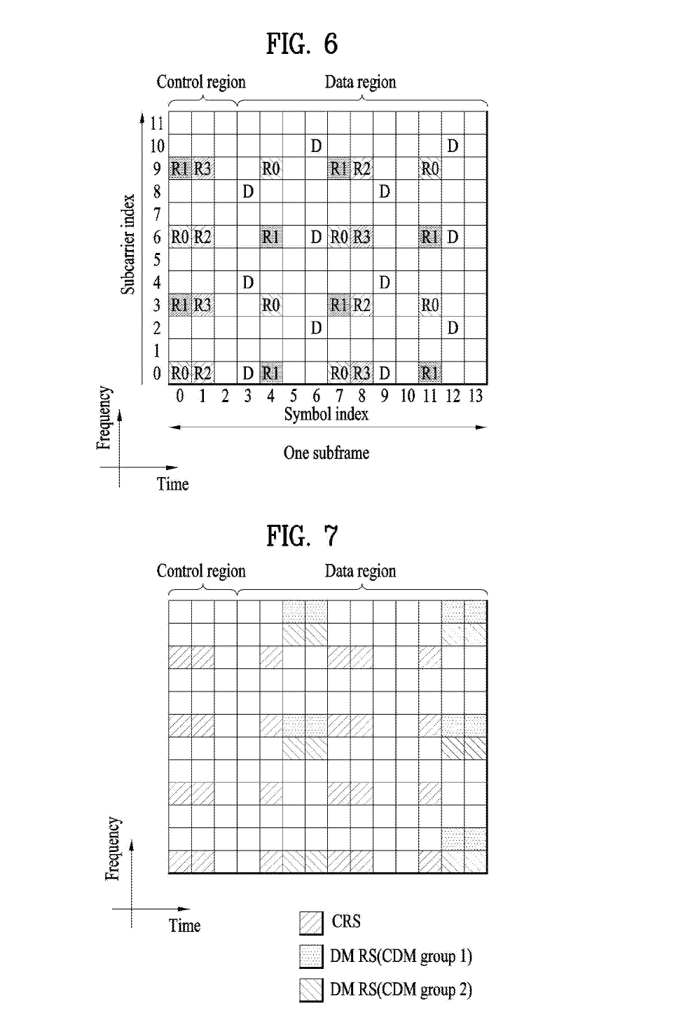

In order to explain a communicating method in an MIMO system in detail, mathematical modeling can be represented as follows. Referring to FIG. 6, assume that N_{T} transmitting antennas and N_{R} receiving antennas exist.

First of all, regarding a transmission signal, if there are N_{T} transmitting antennas, N_{T} maximum transmittable informations exist. Hence, the transmission information may be represented by the vector shown in Equation 2.

s=└s₁,s₂, . . . ,s_{N}_{_{T}}┘^{T} [Equation 2]

Meanwhile, transmission powers can be set different from each other for transmission informations s₁, s₂, . . . , s_{N}_{_{T}}, respectively. If the transmission powers are set to P₁, P₂, . . . , P_{N}_{_{T}}, respectively, the transmission power adjusted transmission information can be represented as Equation 3.

s=[s₁,s₂, . . . ,s_{N}_{_{T}}]^{T}=[P₁s₁,P₂s₂, . . . ,P_{N}_{_{T}}s_{N}_{_{T}}]^{T} [Equation 2]

And, ŝ may be represented as Equation 4 using a diagonal matrix P of the transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Let us consider a case of configuring N_{T} transmitted signals x₁, x₂, . . . , x_{N}_{_{T}}, which are actually transmitted, by applying a weight matrix W to a transmission power adjusted information vector ŝ. The weight matrix W serves to appropriately distribute the transmission information to each antenna according to a transport channel state, etc. x₁, x₂, . . . , x_{N}_{_{T}} may be expressed by using the vector X as follows.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & ⋯ & {w}_{1 {N}_{T} } \\ {w}_{21} & {w}_{22} & ⋯ & {w}_{2 {N}_{T}} \\ ⋮ & & ⋱ & \\ {w}_{i 1} & {w}_{i 2} & ⋯ & {w}_{{iN}_{T}} \\ ⋮ & & ⋱ & \\ {w}_{{N}_{T} 1} & {w}_{{N}_{T} 2} & ⋯ & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

In Equation 5, wᵢⱼ denotes a weight between an i^{th} transmit antenna and j^{th} information. W is also called a precoding matrix.

The transmitted signal x may be differently processed according to two schemes (for example, spatial diversity scheme and spatial multiplexing scheme). In case of the spatial multiplexing scheme, different signals are multiplexed and the multiplexed signal is transmitted to a receiver such that elements of information vector(s) have different values. In case of the spatial diversity scheme, the same signal is repeatedly transmitted through a plurality of channel paths such that elements of information vector(s) have the same value. A combination of the spatial multiplexing scheme and the spatial diversity scheme may be considered. That is, the same signal may be, for example, transmitted through three transmit antennas according to the spatial diversity scheme and the remaining signals may be transmitted to the receiver using the spatial multiplexing scheme.

If the N_{R} receive antennas are present, respective received signals y₁, y₂, . . . , y_{N}_{_{R}} of the antennas are expressed as follows. [Equation 6]

y=[y₁,y₂, . . . ,y_{N}_{_{R}}]^{T}

If channels are modeled in the MIMO wireless communication system, the channels may be distinguished according to transmit/receive antenna indexes. A channel from the transmit antenna j to the receive antenna i is denoted by hᵢⱼ. In hᵢⱼ, it is noted that the indexes of the receive antennas precede the indexes of the transmit antennas in view of the order of indexes.

FIG. 5(b) illustrates channels from the N_{T} transmit antennas to the receive antenna i. The channels may be combined and expressed in the form of a vector and a matrix. In FIG. 5(b), the channels from the N_{T} transmit antennas to the receive antenna i may be expressed as follows.

hᵢ^{T}=[hᵢ₁,hᵢ₂, . . . ,h_{iN}_{_{T}}] [Equation 7]

Accordingly, all the channels from the N_{T} transmit antennas to the N_{R} receive antennas may be expressed as follows.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & ⋯ & {h}_{1 {N}_{T}} \\ {h}_{21} & {h}_{22} & ⋯ & {h}_{2 {N}_{T}} \\ ⋮ & & ⋱ & \\ {h}_{i 1} & {h}_{i 2} & ⋯ & {h}_{{iN}_{T}} \\ ⋮ & & ⋱ & \\ {h}_{{N}_{R} 1} & {h}_{{N}_{R} 2} & ⋯ & {h}_{{N}_{R} {N}_{T}}\end{matrix} ] \qquad [ Equation 8 ]$$

An Additive White Gaussian Noise (AWGN) is added to the actual channels after a channel matrix H. The AWGN n₁, n₂, . . . , n_{N}_{_{R}} respectively added to the N_{R} receive antennas may be expressed as follows.

n=[n₁,n₂, . . . ,n_{N}_{_{R}}]^{T} [Equation 9]

Through the above-described mathematical modeling, the received signals may be expressed as follows.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & ⋯ & {h}_{1 {N}_{T} } \\ {h}_{21} & {h}_{22} & ⋯ & {h}_{2 {N}_{T}} \\ ⋮ & & ⋱ & \\ {h}_{i 1} & {h}_{i 2} & ⋯ & {h}_{{iN}_{T}} \\ ⋮ & & ⋱ & \\ {h}_{{N}_{R} 1} & {h}_{{N}_{R} 2} & ⋯ & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx + n \qquad [ Equation 10 ]$$

The number of rows and columns of the channel matrix H indicating the channel state is determined by the number of transmit and receive antennas. The number of rows of the channel matrix H is equal to the number N_{R} of receive antennas and the number of columns thereof is equal to the number N_{T} of transmit antennas. That is, the channel matrix H is an N_{R}×N_{T} matrix.

The rank of the matrix is defined by the smaller of the number of rows or columns, which are independent of each other. Accordingly, the rank of the matrix is not greater than the number of rows or columns. The rank rank(H) of the channel matrix H is restricted as follows.

rank(H)≦min(N_{T},N_{R}) [Equation 11]

In MIMO transmission, the term ‘rank’ denotes the number of paths for independently transmitting signals, and the term ‘number of layers’ denotes the number of signal streams transmitted through each path. In general, since a transmitting end transmits layers corresponding in number to the number of ranks used for signal transmission, rank has the same meaning as the number of layers unless otherwise specified.

Reference Signal (RS)

Since a packet is transmitted on a radio channel in a wireless communication system, a signal may be distorted in the course of transmission. A receiving end needs to correct the distorted signal using channel information to receive a correct signal. To enable the receiving end to obtain the channel information, a transmitting end transmits a signal known to both a transmitting end and the receiving end. The receiving end obtains the channel information based on the degree of distortion occurring when the signal is received on the radio channel. Such a signal is called a pilot signal or a reference signal.

When data is transmitted and received through multiple antennas, the receiving ends needs to be aware of a channel state between each transmit antenna and each receive antenna to receive the data correctively. Accordingly, each transmit antenna should have a separate reference signal.

In a mobile communication system, reference signals (RSs) are mainly classified into two types according to the purposes thereof: an RS for channel information acquisition and an RS for data demodulation. Since the former RS is used to allow a UE to acquire DL channel information, it should be transmitted over a wide band. In addition, even a UE which does not receive DL data in a specific subframe should be receive and measure the corresponding RS. Such an RS is also used for measurement of handover. The latter RS is transmitted when an eNB sends a resource in downlink. The UE may perform channel estimation by receiving this RS, thereby performing data modulation. Such an RS should be transmitted in a region in which data is transmitted.

The legacy 3GPP LTE (e.g., 3GPP LTE release-8) system defines two types of downlink RSs for unicast services: a common RS (CRS) and a dedicated RS (DRS). The CRS is used for acquisition of information on a channel state, measurement of handover, etc. and may be referred to as a cell-specific RS. The DRS is used for data demodulation and may be referred to as a UE-specific RS. In the legacy 3GPP LTE system, the DRS is used for data demodulation only and the CRS can be used for both purposes of channel information acquisition and data demodulation.

The CRS, which is cell-specific, is transmitted across a wideband in every subframe. Depending on the number of transmit antennas of the eNB, it is possible to transmit CRSs for maximum four antenna ports. For instance, when the number of the transmit antennas of the eNB is two, CRS for antenna ports 0 and 1 are transmitted. If the eNB has four transmit antennas, CRSs for antenna ports 0 to 3 are transmitted.

FIG. 6 illustrates CRS and DRS patterns for one resource block in a system where an eNB has four transmit antennas (in case of a normal CP, one resource block includes 14 OFDM symbols in the time domain×12 subcarriers in the frequency domain). In FIG. 6, REs expressed as ‘R0’, ‘R1’, ‘R2’ and ‘R3’ respectively represent the positions of CRSs for antenna ports 0, 1, 2, and 3 and REs expressed as ‘D’ represent the positions of DRSs defined in the LTE system.

The LTE-A system, which is an evolved version of the LTE system, can support a maximum of 8 transmit antennas on downlink. Accordingly, RSs for up to 8 transmit antennas should be supported. Since downlink RSs are defined for up to four antenna ports in the LTE system, RSs for added antenna ports should be defined when the eNB has more than 4 up to 8 downlink transmit antennas. As the RSs for a maximum of 8 transmit antenna ports, both RSs for channel measurement and RSs for data demodulation should be considered.

One important consideration in design of the LTE-A system is backward compatibility. The backward compatibility refers to support of a legacy LTE UE that can properly operate in the LTE-A system. In terms of RS transmission, if RSs for up to 8 transmit antenna ports are added in a time-frequency region in which CRSs defined in LTE standards are transmitted in every subframe over all bands, RS overhead excessively increases. Hence, when RSs for up to 8 antenna ports are designed, reduction of RS overhead should be considered.

The RSs newly introduced in the LTE-A system may be categorized into two types. One is a channel state information RS (CSI-RS) for channel measurement in order to select a transmission rank, a modulation and coding scheme (MCS), a precoding matrix index (PMI), etc. and the other is a modulation RS (DM RS) used for demodulating data transmitted through a maximum of 8 transmit antennas.

The CSI-RS for channel measurement is mainly designed for channel measurement as opposed to the CRS in the legacy LTE system, used for channel measurement and handover measurement and simultaneously for data demodulation. Obviously, the CSI-RS may also be used for handover measurement. Since the CSI-RS is transmitted only for information acquisition on a channel state, the CSI-RS does not need to be transmitted in every subframe unlike the CRS in the legacy LTE system. Hence, to reduce CRS-RS overhead, the CSI-RS may be designated to be intermittently (e.g. periodically) transmitted in the time domain.

If data is transmitted in a certain downlink subframe, a dedicated DM RS is transmitted to a UE in which data transmission is scheduled. A DM RS dedicated to a specific UE may be designed such that the DM RS is transmitted only in a resource region scheduled for the specific UE, that is, only in a time-frequency region carrying data for the specific UE.

FIG. 7 is a diagram illustrating an example of a DM RS pattern defined in the LTE-A system. FIG. 7 shows the positions of REs carrying DM RSs in one resource block in which downlink data is transmitted (in the case of the normal CP, one resource block includes 14 OFDM symbols in the time domain×12 subcarriers in the frequency domain). The DM RSs may be transmitted for four antenna ports (antenna port indices 7, 8, 9 and 10), which are additionally defined in the LTE-A system. The DM RSs for different antenna ports may be distinguished with each other by different frequency resources (subcarriers) and/or different time resources (OFDM symbols) at which they are located. (i.e., the DM RSs may be multiplexed according to an FDM and/or TDM scheme). In addition, the DM RSs for different antenna ports located on the same time-frequency resources may be distinguished by orthogonal codes (i.e., the DM RSs may be multiplexed according to a CDM scheme). In the example of FIG. 7, DM RSs for antenna ports 7 and 8 may be located at REs expressed as DM RS CDM group 1 and they may be multiplexed by orthogonal codes. Similarly, in the example of FIG. 7, DM RSs for antenna ports 9 and 10 may be located at REs expressed as DM RS CDM group 2 and they may be multiplexed by orthogonal codes.

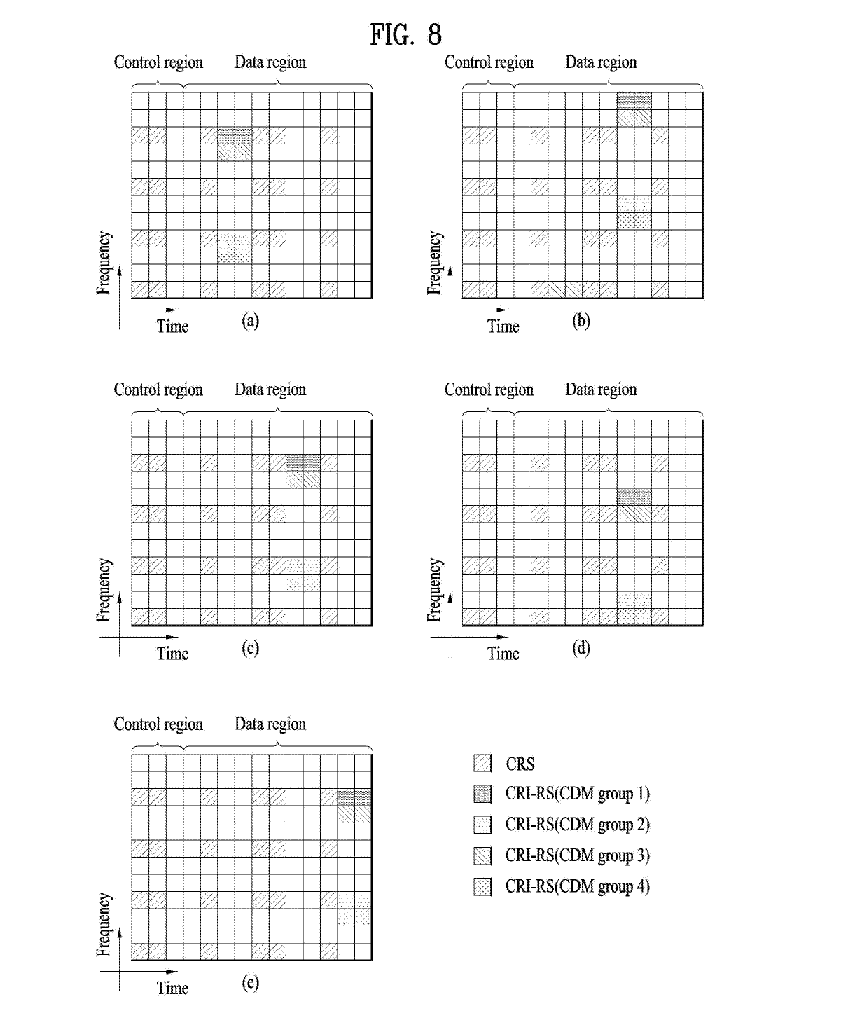

FIG. 8 is a diagram illustrating examples of a CSI-RS pattern defined in the LTE-A system. FIG. 8 shows the positions of REs carrying CSI-RSs in one resource block in which downlink data is transmitted (in the case of the normal CP, one resource block includes 14 OFDM symbols in the time domain×12 subcarriers in the frequency domain). One of the CSI-RS patterns shown in FIGS. 8(a) to 8(e) may be used in any downlink subframe. The CSI-RSs may be transmitted for 8 antenna ports (antenna port indices 15, 16, 17, 18, 19, 20, 21, and 22) additionally defined in the LTE-A system. The CSI-RSs for different antenna ports may be distinguished with each other by different frequency resources (subcarriers) and/or different time resources (OFDM symbols) at which they are located. (i.e., the CSI-RSs may be multiplexed according to the FDM and/or TDM scheme). The CSI-RSs for different antenna ports located on the same time-frequency resources may be distinguished by orthogonal codes (i.e. The CSI-RSs may be multiplexed according to the CDM scheme). In the example of FIG. 8(a), CSI-RSs for antenna ports 15 and 16 may be located at REs expressed as CSI-RS CDM group 1 and they may be multiplexed by orthogonal codes. In the example of FIG. 8(a), CSI-RSs for antenna ports 17 and 18 may be located at REs expressed as CSI-RS CDM group 2 and they may be multiplexed by orthogonal codes. In the example of FIG. 8(a), CSI-RSs for antenna ports 19 and 20 may be located at REs expressed as CSI-RS CDM group 3 and they may be multiplexed by orthogonal codes. In the example of FIG. 8(a), CSI-RSs for antenna ports 21 and 22 may be located at REs expressed as CSI-RSs CDM group 4 and they may be multiplexed by orthogonal codes. The same principle as described with reference to FIG. 8(a) may be applied to FIGS. 8(b) to 8(e).

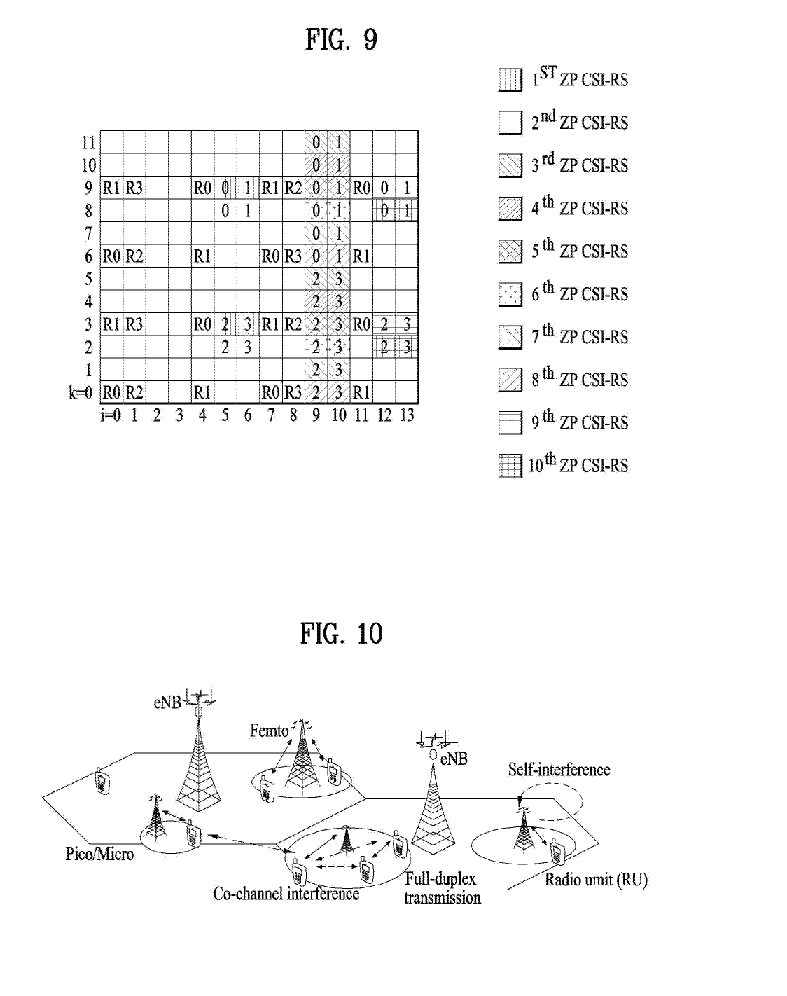

FIG. 9 is a diagram illustrating an example of a zero-power (ZP) CSI-RS pattern defined in the LTE-A system. There are two main purposes of a ZP CSI-RS. First of all, the ZP CSI-RS is used for CSI-RS performance improvement. That is, in order to improve performance of measurement for CSI-RS of a different network, a network may perform muting on a CSI-RS RE of the different network and then inform a UE in the corresponding network of the muted RE by setting it to the ZP CSI-RS in order for the UE to perform rate matching correctly. Second, the ZP CSI-RS is used for the purpose of measuring interference for a CoMP CQI calculation. That is, if a certain network performs muting on a ZP CSI-RS RE, a UE can calculate a CoMP CQI by measuring interference from the ZP CSI-RS.

The RS patterns of FIGS. 6 to 9 are purely exemplary and various embodiments of the present invention is not limited to a specific RS pattern. In other words, even when an RS pattern different from the RS patterns of FIGS. 6 to 9 is defined and used, the various embodiments of the present invention can be applied in the same manner.

Full Duplex Radio (FDR) Transmission

The FDR system means a system that enables a transmitting device to simultaneously perform transmission and reception through the same resource. For instance, an eNB or a UE supporting the FDR may perform transmission by dividing uplink/downlink into frequency/time without duplexing.

FIG. 10 illustrates an example of a system supporting FDR.

Referring to FIG. 10, there are two types of interference in the FDR system.

The first type of interference is self-interference (SI). The SI means that a signal transmitted from a transmit antenna of an FDR device is received by a receive antenna of the corresponding FDR device, thereby acting as interference. Such SI can be referred to as intra-device interference. In general, a self-interference signal is received with high power compared to a desired signal. Thus, it is important to cancel the SI through interference cancellation.

The second type of interference is inter-device interference (IDI). The IDI means that a UL signal transmitted by an eNB or a UE is received by a neighboring eNB or another UE, thereby acting as interference.

Since half-duplex (e.g., FDD, TDD, etc.) in which frequency or time is allocated for each of uplink and downlink has been used in the legacy communication system, interference has not been occurred between uplink and downlink. However, in an FDR transmission environment, since the same frequency/time resource is shared between uplink and downlink, the above-mentioned interference occurs.

Although interference from a neighboring cell occurring in the legacy system is also present in the FDR system, it is not described in the present invention.

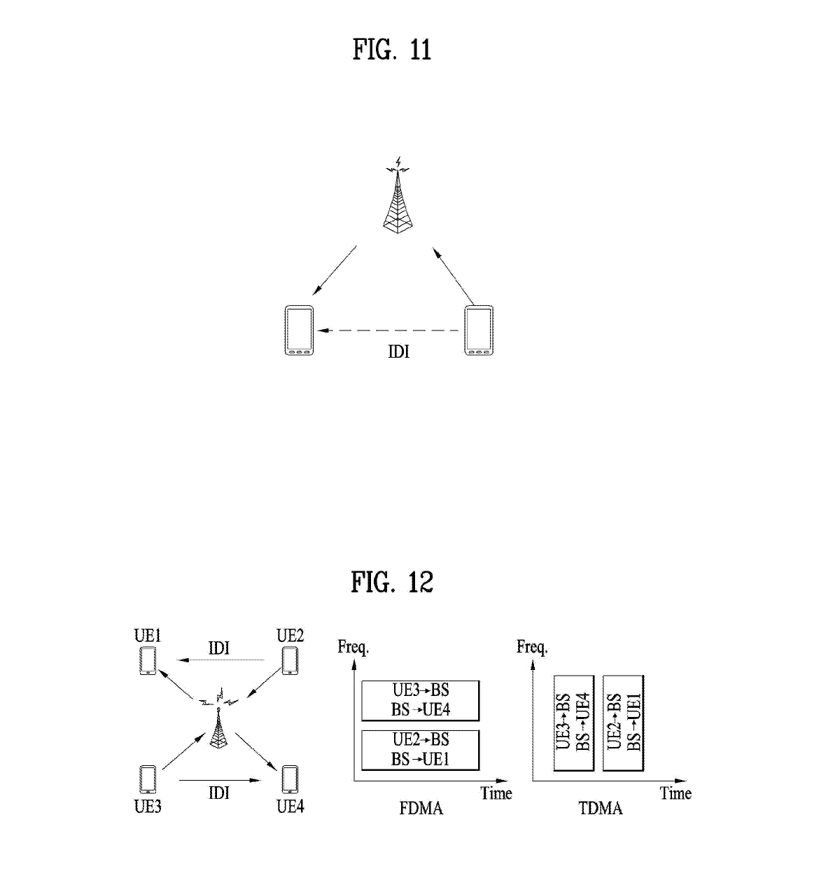

FIG. 11 illustrates an example of inter-device interference.

As described above, the IDI occurs only in the FDR system due to the same resource used in a cell. Referring to FIG. 11, an uplink signal transmitted by UE1 to an eNB may acts as interference to UE2. Although FIG. 11 simply shows the two UEs for convenience of description of the IDI, the technical features of the present invention is not limited to the number of UEs.

FIG. 12 illustrates examples of FDMA and TDMA operations when a BS operates in FD (full duplex) mode on the same resource and UEs perform multiple access.

In the FDR system, not only the FD operating on the same resource but also FD operating on different resources is present.

Referring to FIG. 12, there are a total of two groups that performs an FD operation on the same resource. One group includes UE1 and UE2 and the other group includes UE3 and UE4. Since IDI occurs in each group using the same resource, it is preferred to configure UEs in which IDI occurs less frequently as a group.

For instance, when interference caused by the UE2 affects more to the UE4 than the UE1, the UE1 and the UE2 can be grouped as shown in FIG. 12.

Meanwhile, if the amount of the IDI caused by the UE2 is too large, the IDI may also affect the UE1. In this case, the UE1 and the UE2 may be configured not to use the same resource. For instance, in case of FDMA, a total of three frequency bands can be allocated such that the UE3 and the UE4 use the same frequency region and the UE1 and the UE2 use different frequency regions. In this case, although resource consumption is increased, efficient transmission can be achieved, for example, in terms of throughput.

Accordingly, a technique for selecting UEs to perform the FD operation on the same resource from a plurality of UEs is necessary but the related art does not have an implementation method therefor.

As a similar technique, a method of measuring inter-cell interference or a method of selecting a cell depending on interference has been used in a CoMP (coordinated multi-point) filed. In the CoMP, a UE located at a boundary between cells measures interference of neighboring cells and then determines an eNB. However, the interference in the CoMP means signals from several cells that affect the UE. In addition, since the UE does not share resources with other UEs, IDI to neighboring UEs is not considered.

As another technique, a multi-user MIMO method or a virtual MIMO method means that UEs with a single antenna are combined in order to configure an eNB and a virtual MIMO system having multiple antennas. In the multi-user MIMO, UEs receive DL transmission information for other UEs when performing DL transmission and thus IDI occurs. In this case, an eNB performs scheduling on UEs of which channels are orthogonal to those of the eNB in order to avoid the IDI. However, the IDI described herein is different from the above-mentioned IDI in that the present invention describes the IDI in the FD where not only DL transmission but also UL transmission is simultaneously performed.

In the present invention, a method of determining a UE group and a method of measuring and reporting IDI by using the determined UE group will be proposed in order to avoid or mitigate interference between UEs (i.e., IDI) in a system using full-duplex communication on the same resource.

In the present invention, a device (e.g., eNB or UE) that supports FD (full duplex) mode on the same resource is referred to as an FDR device, eNB, or UE.

An FDR device may include a self-interference canceller and the FDR device containing the SI canceller may support/operate FD mode on the same resource. The FDR device without the SI canceller may not operate in the FD mode on the same resource. However, since the FUR device without the SI canceller can exchange information with the FDR device operating in the FD mode on the same resource, it can support the FD mode. In other words, the FDR device without the SI canceller may also measure and report the IDI. For example, the eNB shown in FIG. 11 may correspond to the FDR device with the SI canceller and the UE1 and UE2 may correspond to the FDR device without the SI canceller.

The grouping mentioned in the present invention means that a plurality of UEs are grouped according to a specific standard.

In addition, according to the present invention, a group is configured based on IDI-related information measured by a UE. That is, since a UE is a main agent of the group configuration, the grouping of the present invention may be referred to as a UE-specific grouping.

Hereinafter, the present invention is mainly described based on a case in which an eNB operates in the FD mode on the same resource. However, the present invention can also be applied to a case in which a UE operates in the FD mode on the same resource and even a case in which the UE operates in the FD mode on the same resource when there is no intervention of the eNB like D2D communication. Details of these cases will be described after explanation of the former case. Although each case will be described separately from the other, they may simultaneously occur in a cell and also be applied simultaneously.

### 1. First Embodiment

In the first embodiment of the present invention, described is a method for configuring an initial group that shares the same resource when an FD operation can be performed on the same resource.

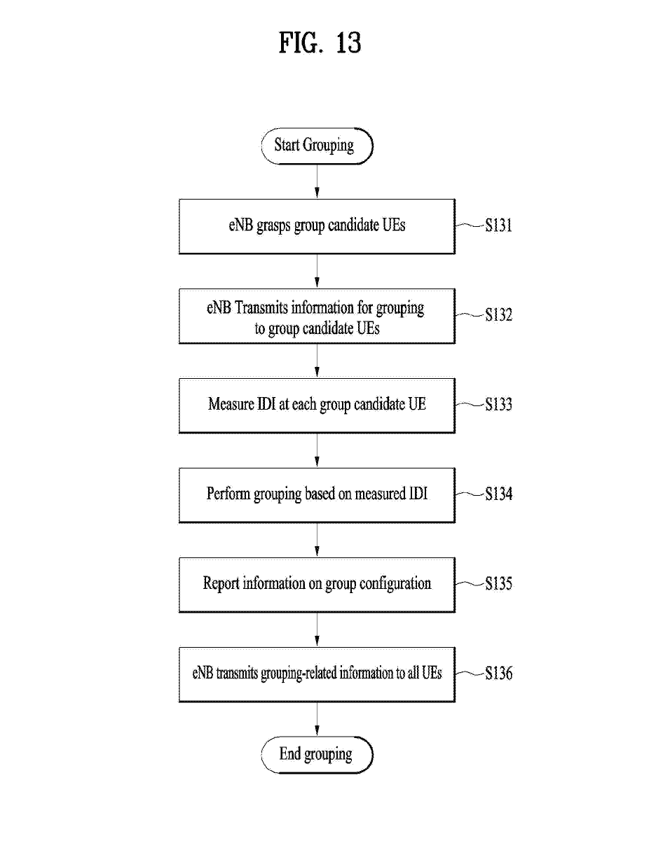

FIG. 13 is a flowchart for explaining an initial grouping configuration method according to the first embodiment of the present invention.

An initial grouping is performed to initially apply FD mode on the same resource in a cell.

Hereinafter, a procedure for the initial grouping is described in brief. First of all, an eNB grasps UEs that intend to participate in the grouping [S131]. In this case, the eNB may selects candidates UEs in consideration of whether a UE has a capability of operating the FD mode on the same resource. After selecting the candidate UEs, the eNB transmits information or indication necessary for the grouping to the candidate UEs [S132]. The candidate UEs measure IDI [S133] and perform the grouping based on the measured IDI [S134]. After performing the grouping, each UE reports grouping-related information to the eNB [S135]. Thereafter, the eNB transmits the grouping-related information received from the UEs to all UEs [S136].

Hereinafter, each step shown in FIG. 13 will be described in detail.

1.1 Prehension of Candidate UE

First of all, in the step S131, the eNB grasps the candidate UEs to be configured as a group.

As a first method for grasping the candidate UEs, the eNB may request all UEs connected to the eNB to transmit information indicating whether the UEs participate in the grouping. For instance, the request information may be transmitted through a DCI format of a PDCCH or an E-PDCCH or a PDSCH. In response to the request information, a UE may transmit a response indicating whether the UE participates in the grouping. For instance, the response information may be transmitted through a UCI format of a PUSCH or a PUCCH.

As a second method, each UE may transmit a request of participation. That is, each UE may transmit the request for participating in the FD mode on the same resource by considering characteristics of data to be transmitted. Such information may be transmitted to the eNB through the UCI format of the PUSCH or the PUCCH.

As a third method, the eNB may be aware of information on UEs in advance. That is, the eNB may know characteristics of data to be transmitted by UEs or recognize which UEs desire to participate in the FD mode on the same resource. For instance, there may be a case in which although UEs are ready to participate in the grouping, the UEs do not currently participate in the FD mode on the same resource. In this case, the eNB may transmit, to the corresponding UEs, information for asking whether the UEs participate. Such information may be transmitted through the DCI format of the PDCCH or the E-PDCCH or the PDSCH.

In this case, information on whether a UE to participates in the grouping may include information on whether the UE is the FDR device (including the SI canceller) capable of operating in the FD mode on the same resource, information on whether the UE is the FDR device that cannot be operated in the FD mode on the same resource but can support the FD mode on the same resource, or information on whether the UE is the FDR device and also desires to participate in the grouping. As described above, the FDR device may include the SI (self-interference) canceller and the FDR device with the SI canceller may operate/support the FD mode on the same resource. The FDR device without the SI canceller may not operate in the FD mode on the same resource. However, since the FUR device without the SI canceller can exchange information with the FDR device operating in the FD mode on the same resource, it can support the FD mode. In other words, the FDR device without the SI canceller may also measure and report the IDI.

The above-mentioned three types of information can be assigned to the UCI format. For instance, a total of three bits may be assigned to the UCI format and the three bits are respectively assigned for the three types of information. In case of a positive answer, each bit can be set to ‘1’. In case of a negative answer, each bit can be set to ‘0’ and vice versa.

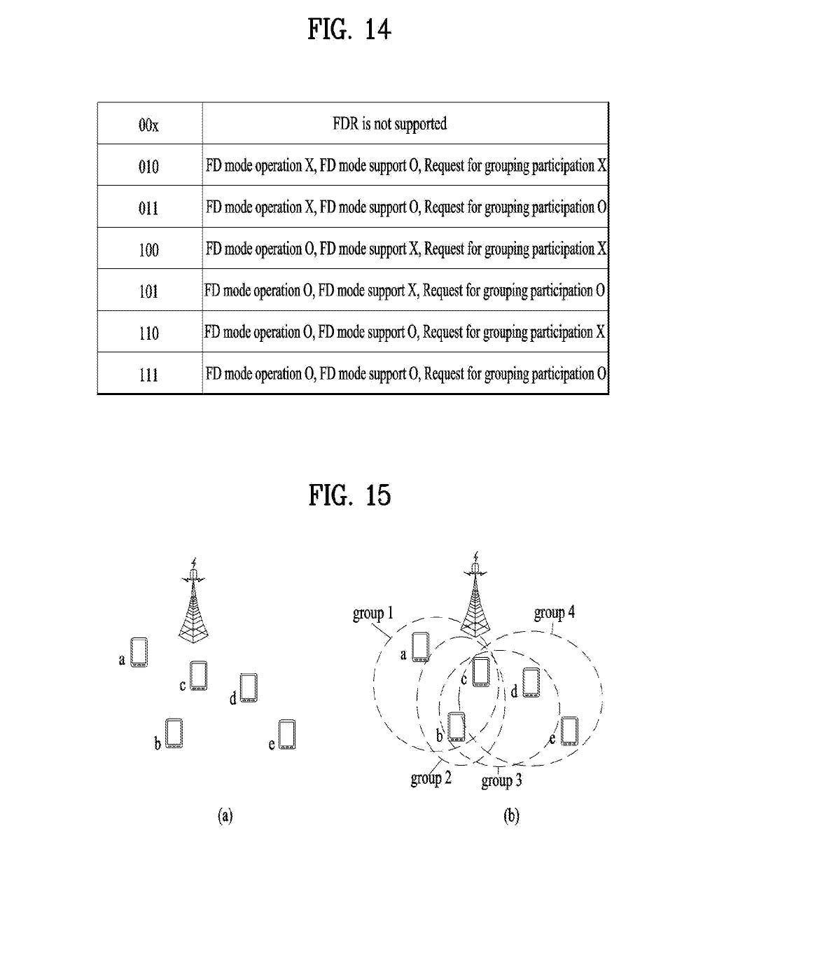

FIG. 14 illustrates an example of assigning bits indicating whether a UE participates in a grouping.

For instance, when ‘011’ is assigned, it indicates that a UE cannot be operated in the FD mode on the same resource but supports the FD mode on the same resource and also desires to participate in the current grouping, similar to the UEs in FIG. 11. In case of a UE that does not participate in the grouping, ‘000’ can be assigned in order to support an operation of the legacy system.

The FDR device may change a grouping participation request bit in consideration of characteristics of transmitted data, a remaining (remain) power profile, a buffer state, and the like. In addition, the FDR device may be configured to not support the FD mode or not operate in the FD mode in order to reduce time required in grasping the bits, which are assigned by the eNB for UEs.

It is preferred to transmit the bits related to FD mode operation and the FD mode support only when a UE initially participates in the grouping or the UE re-participates in another grouping after the UE withdraws from the group. When a group configuration is completed, the eNB may set a UE_ID of the UE that can only support the FD mode to ‘0’ and a UE_ID of the UE that can be operated in the FD mode to ‘1’.

In the case of the UE that can be operated in the FD mode, a bit indicating how the UE operates in the FD mode can be assigned to the UCI format additionally. For instance, if the corresponding bit is set to ‘0’, it indicates that the UE supports the FD mode. If the bit is set to ‘1’, the FD mode operation may be indicated in order to inform an operation method. After grasping the bits related to the FD mode operation, the eNB may use them to allocate resources.

1.2 Transmission of Information for Grouping

In the step S132, the eNB transmits the information for the grouping to the candidate UEs selected through the step S131.

For example, the information for the grouping may include information on whether a UE is selected as the candidate UE, information on frequency to be used, and the total number N of grouping candidate UEs. The eNB may transmit the information for the grouping by assigning bits to the DCI format of the PDCCH or the PDSCH.

The eNB may limit the number of operating UEs due to the total number of UEs that can be managed by the UEs. In addition, in the step 131, the eNB may inform the UE, which has been notified that the UE could participate in the grouping, of whether the corresponding UE is selected as the grouping candidate UE or not. In this case, a UE that is not selected as the candidate UE by the eNB is preferred to operate in fallback mode. Here, the fallback mode means that the UE operates according to the conventional Half-duplex mode or in the FD mode on different frequency.

1.3 IDI Measurement

In the step S133, the grouping candidate UE measures IDI caused by (N−1) of the remaining neighboring UEs except the grouping candidate UE. The IDI of the neighboring UEs can be measured as follows.

Since the IDI occurs due to the use of the same resource, one UE transmits a UL signal in each of a total of N subframes whereas the remaining (N−1) UEs receives DL signals. By doing so, an RSRP (reference signal received power) or an RSRQ (reference signal received quality) of the IDI may be measured.

The magnitude of the IDI for each target UE may be defined as a function having, as variables, a distance between the measuring UE and the target UE, a transmit power of the target UE, and a transmission direction of the target UE.

Meanwhile, all N UEs included in the grouping candidates may become measuring UEs. In this case, a signature signal may be used to identify the UEs.

1.4 UE-Specific Grouping

In the step S134, each UE that intends to perform the grouping may configure a group with other UEs by considering a specific threshold based on the measured IDI value or by considering a size of each predetermined group. When all of the UEs intend to perform the grouping for the total number N of UEs, the maximum number N of groups can be configured. A group ID is configured for UEs belonging to each group. In this case, since the main agent of the grouping is a UE, one or more group IDs may be assigned to each UE.

The minimum size of a group is 1 and it corresponds to a case in which the IDI value is significantly different from the threshold. That is, it means that the number of UEs included in the group is 1 and in this case, the UE operates in the fallback mode.

As a first method for performing a grouping of UEs based on IDI at a UE, it is possible to configure a group of UEs in which the IDI occurs frequently. For instance, it is possible to configure a group of UEs having IDI values equal to or greater than a specific threshold. Such a grouping can be defined as a grouping based on the worst relation. According to the above grouping, UEs that cause high-IDI to each other are combined into a group.

As a second method for performing a grouping of UEs based on IDI at the eNB, it is possible to configure a group of UEs in which the IDI occurs less frequently. For instance, it is possible to configure a group of UEs having IDI values equal to or less than the specific threshold. Such a grouping can be defined as a grouping based on the best relation. According to the above grouping, UEs that cause low-IDI to each other are combined into a group.

In each of the individual groups configured according to the two methods, resource allocation in the group can be performed as follows.

In the group with the worst relation, the IDI value between UEs in the group is greater than the threshold. Thus, an IDI avoidance technique (e.g., beamforming technique) can be applied when the UEs in the group use the same resource. If the UEs in the group perform uplink transmission and other UEs that do not belong to the group perform downlink transmission and vice versa, it may become advantageous to multi-user MIMO transmission.

In the group with the base relation, two UEs of UEs in the group may be operated in the FD mode on the same resource. In addition, the UEs in the group may be operated according FDM multiplexing.

The FU mode using the same resource can be performed between the group with the worst relation and the group with the base relation. In this case, a successive cancellation method, which is one of interference cancellation methods, needs to be applied. As a signal strength difference between interference signals increases, the performance of the SC method increases. For instance, in case that a first UE, a second UE included in a group having the worst relation with the first UE, and a third UE included in a group having the best relation with the first UE are selected by the eNB and the three UEs support the FU mode on the same resource, if the SC method is sequentially applied to the second UE in the group having the worst relation and the third UE in the group having the best relation, it shows high performance compared to a case in which the eNB selects UEs from groups having normal relations.

FIG. 15 (a) shows an example of deploying an eNB and five UEs for a UE-specific grouping and FIG. 15 (b) shows an example of a group configuration when a grouping based on the worst relation is completed. The example of FIG. 15 (b) corresponds to a result of the UE-specific grouping performed by all UEs except UE E. In this case, the UEs are deployed on the assumption that IDI is proportional to a distance between UEs.

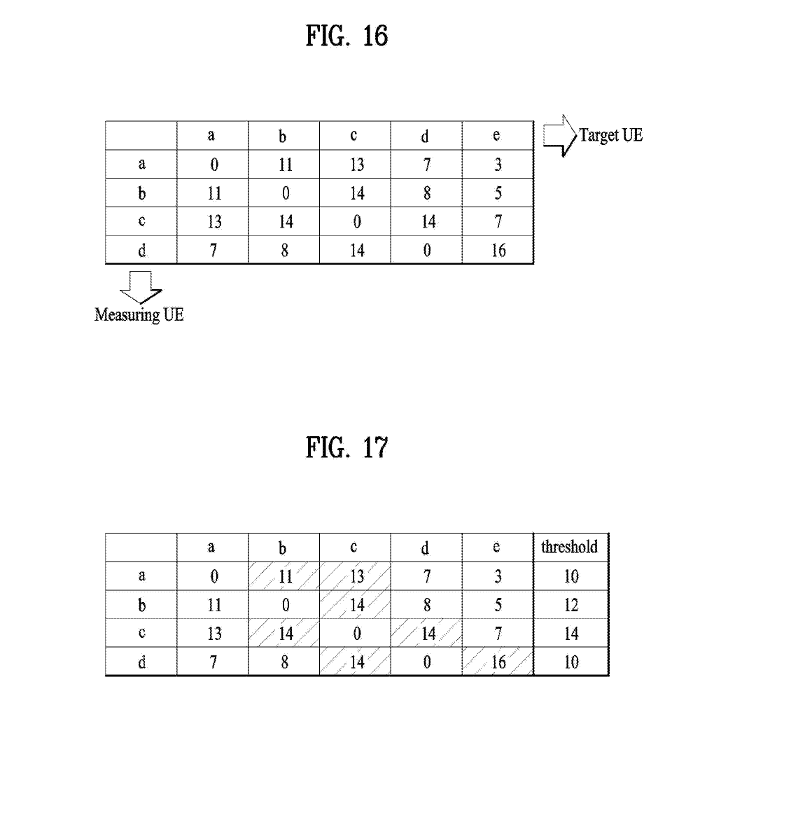

FIG. 16 illustrates examples of IDI values measured by individual UEs. Here, the IDI value depends on the distance. In addition, since the UE E does not perform the grouping, it is excluded from a list of IDI-measuring UEs.

The first column of FIG. 16 shows IDI-measuring UEs and the first row shows ID-measuring targets. When the measuring UE is identical to the target UE, the IDI measurement is not only unnecessary but also meaningless and thus it is expressed as ‘0’.

FIG. 17 illustrates how each UE selects target UEs for a group configuration. Threshold values of UEs that lead the group configuration is shown in the most right column of FIG. 17.

In FIG. 17, IDI values greater than threshold values in the worst case (i.e. worst relation) are shown in shaded areas.

For instance, the first row shows IDI values measured by UE A with respect to the remaining UEs. The interference values measured by the UE A with respect to UE B to the UE E are 11, 13, 7, and 3 respectively. Since a threshold is 10, the UE A may perform the grouping based on the worst relation with the UE B and the UE C.

On the contrary, In FIG. 17, the grouping based on the base relation may be performed in a manner of selecting UEs with IDI less than the threshold.

For instance, according to the first row, the UE A may perform the grouping based on the best relation with the UE D and the UE E having IDI less than the threshold.

1.5 UE's Reporting of Information Related to Group

In the step S135, the UEs that lead the group configuration may transmit UE_IDs of UEs included in the corresponding group to the eNB (through the PUSCH). In this case, a bit is assigned to inform which UE leads the group configuration and then the bit may be transmitted through the UCI format of the PUCCH or the PUSCH. For instance, a UE may set the corresponding bit to ‘1’ and then transmit the bit set to ‘1’ in order to notify the eNB that the UE leads the group configuration. After checking the UE_IDs transmitted by the corresponding UE, the eNB may know the UEs that belong to the same group.

After receiving the group-related information from the individual UEs, the eNB can grasp the number of UEs included in each group. If the size of a specific group is equal to or greater than a predetermined value, it means that IDI caused by a target UE significantly affects a measuring UE. Thus, the eNB may perform independent resource allocation for the corresponding measuring UE.

In addition, a UE may transmit additional information such as the measured IDI value that can be reflected in a later grouping as well as the information indicating whether the UE leads the group configuration and the UE_IDs to the eNB. For instance, quantized information on UE's IDI-processing capability may be transmitted (through the UCI format of the PUCCH or the PUSCH). Additionally, the best band determined from a CSI channel, which is fed back by a UE, and UE's remaining (remain) power profile, and the like may be transmitted (through the UCI format of the PUCCH or the PUSCH). When performing scheduling, the eNB may allocate resource by reflecting such information.

1.6 eNB Transmits Grouping-Related Information to all UEs

In the step S136, the eNB may transmit information such as measurement/reporting periods to all UEs based on the received grouping information. Such information may be transmitted through higher layer signaling. Alternatively, if there is no information to be transmitted, the eNB may skip the step S136.

Further, the eNB may transmit information for adjusting the grouping for a specific UE.

For instance, if UE A desires to be allocated frequency independently in the grouping based on the worst relation, the eNB may instruct to either increase or decrease a threshold for a target UE A. Alternatively, the eNB may instruct a multi-threshold. For instance, if the eNB desires to allocate independent frequency to the UE C in FIG. 17, the eNB may increase the threshold for the target UE C to 15 and decrease the threshold for the measuring UE to 5.

### 2. Second Embodiment

The second embodiment of the present invention relates to a method of performing grouping update after completing the initial grouping according the first embodiment.

The grouping update means that the group configuration can be either maintained or updated due to IDI re-measurement and reporting in a situation that the group operates in the FD mode on the same resource. That is, the configured group may be changed due to participation of a new candidate UE or withdrawal of the existing candidate UE.

FIG. 18 is a flowchart for explaining grouping update according to the second embodiment.

Hereinafter, a procedure for the grouping update is described in brief. First of all, the eNB checks whether there is a new candidate UE that desires to participate in the grouping or whether there is a UE that desires to terminate participation in the FD mode on the same resource [S1801]. If the eNB detects the new candidate UE, the eNB notifies all groups that IDI of the corresponding candidate UE needs to be measured. In addition, if the eNB detects the UE that desires to terminate the participation in the FD mode, the eNB notifies the presence of the UE to groups that measure the corresponding UE [S1803]. If there is no UE to be changed, the eNB may change a UE grasp period, an IDI measurement period, and a group configuration reporting period [S1804]. Each UE may measure its IDI according to the configured period [S1806] or according to instruction from the eNB [S1807]. After updating group information [S1808], an IDI-measuring UE may report the updated information to the eNB at the configured period [S1810] or according to instruction from the eNB [S1811]. Thereafter, the eNB transmits updated group-related information to the corresponding UEs based on the reported information [S1812].

Hereinafter, each steps in FIG. 18 will be described in detail.

2.1 Understanding of Grouping Candidate UE

In the step S1801, the eNB may check whether there is a new candidate UE that desires to participate in the grouping or whether there is a UE that desires to terminate the participation in the FD mode on the same resource.

If the UE terminates the participation in the FD mode, the UE may operate in the fallback mode.

2.1.1 Method of Grasping Grouping Candidate UEs

The eNB may check UEs participating in the FD mode on the same according to the following methods.

As a first method, the FDR device assigns a 1-bit on whether a corresponding UE belongs to a group to the UCI format of the PUCCH or the PUSCH and then use the 1-bit together with the grouping participation request bit of FIG. 14 in order to grasp candidate UEs that desire to participate in or withdraw from the grouping. For instance, if the grouping participation request bit is set to ‘1’ and the bit indicating whether the corresponding UE belongs to the group is set to ‘0’, the eNB knows that the corresponding UE is a new candidate UE that desires to participate in the grouping.

FIG. 19 illustrates an example of grasping a grouping candidate based on a grouping participation request and whether the grouping candidate belongs to a group.

As a second method, the eNB may grasp a grouping participation/withdrawal candidate UE using the grouping participation request bit of FIG. 14. If the eNB has a group ID of the configured group and UE_IDs of UEs included in the group, the bit indicating whether a UE belongs to a group may be replaced. For instance, if the grouping participation request bit is ‘1’ and a UE_ID of a specific UE does not match with one of the stored UE_IDs, the eNB may recognize that the specific UE desires to participate in the grouping.

As a third method, the eNB may transmit the grouping participation request bit by considering a state in which a UE has belonged to a group (e.g., by receiving a group ID). In this case, the bit indicating whether the UE belongs to the group may be replaced. If the grouping participation request bit is set to ‘0’, the eNB may recognize that the corresponding UE desires to terminate the participation in the FM mode. If the grouping participation request bit is set to ‘1’, the eNB may recognize that the corresponding UE desires to participate in the grouping.

2.1.2 Grouping Candidate Grasp Time

The eNB may instruct a UE to perform the grouping update periodically. Specifically, all UEs participating in the FD mode may perform the grouping update through the steps S1803 and 1805. The grouping candidate UE grasp time and relevant operations can be determined as follows.

As a first method, the eNB may grasp grouping candidate UEs whenever performing the grouping update.

As a second method, the eNB may periodically grasp the grouping candidate UEs at a candidate UE grasp period. The candidate UE grasp period may be fixed. Alternatively, the candidate UE grasp period may be gradually increased in a situation in which a group is not frequently changed. If the group is changed or a new grouping candidate UE is detected, the increased period may be switched to the original period.

Unlike the grouping update period, the candidate UE grasp period may be determined according to the following methods. As a first method, the candidate UE grasp period may be set smaller than the grouping update period. This may be used in case that the eNB desires to detect the UEs that terminate the participation in the FD mode in some groups at every candidate UE grasp period. As a second method, the candidate UE grasp period may be set greater than the grouping update period. This method has an advantage in that the load of detecting candidate UEs is reduced. If the grouping update is performed before the candidate UE grasp period is completed, the eNB may recognize that there is no UE that desires to change the grouping.

As a third method, when there is a request from a UE, the eNB may grasp the grouping candidate UEs in response to the request. For instance, when power of a UE is turned on or an FDR device is activated by a user, the UE may request to participate in the grouping. On the contrary, when power of a UE is tuned off, an FDR device is deactivated by a user, or the remaining amount of a battery is lower than a certain level, the UE may request to terminate the FD mode. In this case, the eNB may grasp the candidate UEs instantaneously or at a predetermined period. Alternatively, when a UE changes its group, the corresponding UE may request to perform the grouping update.

Further, when the second method and the third method are simultaneously used, the period may be increased. It has an advantage in that the load of detecting candidate UEs is reduced.

2.1.3 Grasp of Grouping Candidate UE when UE Changes Group

The grouping update may be required not only when there is the new candidate UE that participates in the grouping or the UE that terminates the participation in the FD mode on the same resource as described above, but also when UEs include in the previously configured groups change their groups. When a UE changes its group, operations therefor can be performed according to the following methods.

As a first method, all of the UEs may be updated whenever the grouping update is performed or at a predetermined period.

As a second method, when a state of a UE is changed more than a predetermined level, for instance, when the UE moves at a high speed, the corresponding UE can operate in the fallback mode. In this case, since it may be interpreted as that the UE terminates the participation in the FD mode, the UE is excluded from the grouping update. However, the UE may participate in the grouping as a new candidate UE in the next grouping update.

As a third method, a new candidate UE that will participate in the grouping may directly send a request. For instance, the UE may send the request by setting the groping participation request bit to ‘1’ and the bit indicating whether the UE belongs to the group to ‘0’. After receiving the request, the eNB determines whether a UE_ID of the corresponding UE is included in an IDI measurement target list or a configured group ID. When the bit indicating whether the UE belongs to the group set to ‘0’ is received, the grouping update can be performed even though the configured group ID is present.

2.1.4 Method of Allocating IDI Measurement Frequency for Grouping Candidate UE

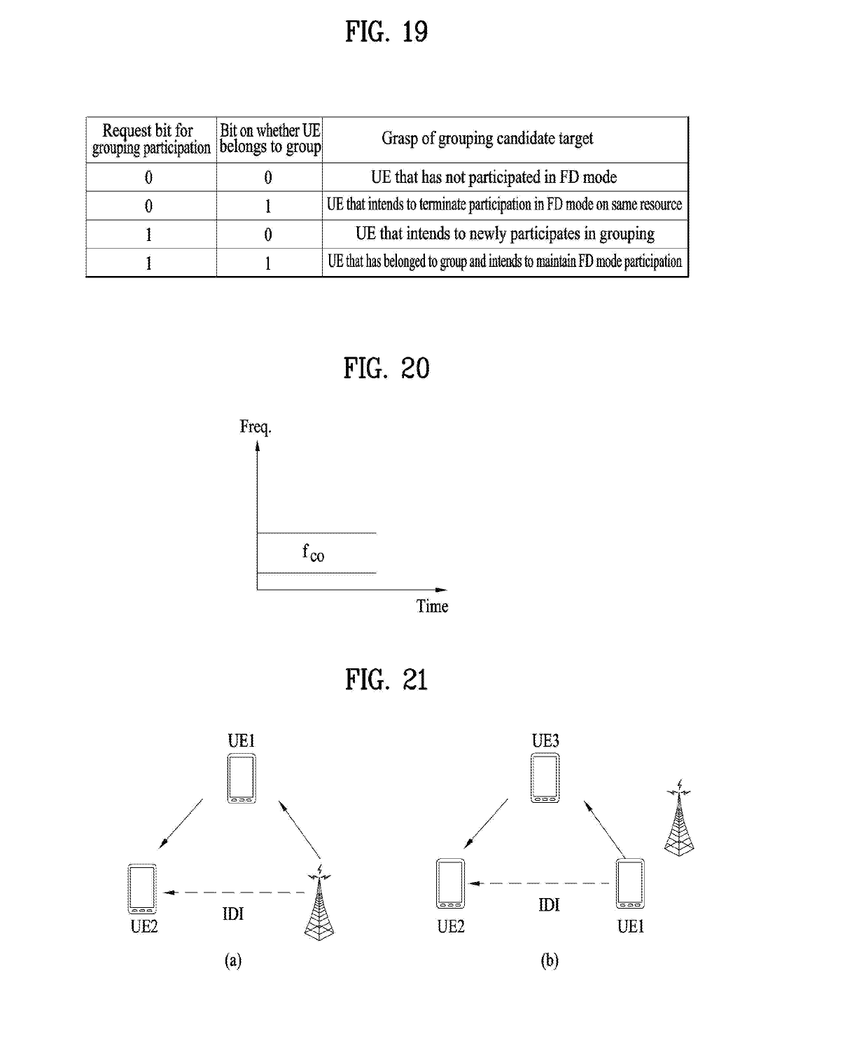

In the step S1801, the eNB may allocate frequency for IDI measurement to grouping candidate UEs as shown in FIG. 20.

FIG. 20 (a) shows an example of allocating common frequency (fco) for IDI measurement to all UEs. In this case, N UEs uses N subframes for IDI measurement with respect to all UEs as described in the step S1303.

FIG. 20 (b) shows an example of allocating different IDI measurement frequency to a first time region and a second time region.

In the second time region, if both of the grouping participation request bit and the bit indicating whether a UE belongs to a group are set to ‘1’, exclusive frequency (f1, f2, and f3) is allocated for each group during a prescribed time. UEs in each group use frequency allocated for the corresponding group in common.

In the first time region, when the grouping participation request bit is set to ‘1’ and the bit indicating whether a UE belongs to a group is set to ‘0’, that is, when there is a UE that newly participates in the grouping, the common frequency (fco) is allocated to all of the UEs to measure such a UE.

For instance, assuming that the number of UEs included in each of three groups is A and the number of UEs that newly participate in the grouping is B, the exclusive frequency is allocated during a time amounting to the number A of subframes and the common frequency is allocated during a time amounting to the number B of subframes. In this case, B UEs transmit uplink signals during B subframes and the remaining 3*A+(B−1) UEs can measure IDI by receiving downlink signals during the same time.

According the method shown in FIG. 20 (a), a total of (3*A+B) subframes are required for the IDI measurement. On the other hand, according the method shown in FIG. 20 (b), a total of (A+B) subframes are required for the IDI measurement.

If a UE in a group moves, the UE may be re-grouped into another group. In this case, a channel state may not be reflected and thus the above-mentioned two methods can be simultaneously performed at two different periods. Hereinafter, for convenience of description, when a UE changes its current group to another group, it is considered as that a grouping candidate target UE is changed.

2.2 Grouping Target UE Change

After grasping the grouping candidate target UE in the step S1801, the eNB may transmit information on a UE of which the group is changed through the steps S1802 and S1803 according to the following methods.

First of all, the eNB may assign a new UE_ID to the UE that will participate in the grouping and then inform grouping update target UEs (i.e., another new UE that desires to participate in the grouping and all UE in the current group except the UE that terminates the FD mode participation) of the corresponding UE_ID or a IDI measurement target list including the corresponding UE_ID. Such information may be transmitted through the PDCCH or the PDSCH. The IDI measurement target list may include UE_IDs of the grouping update target UEs or UE_IDs of UEs belonging to other groups.

In addition, the eNB may transmit the UE_ID or the IDI measurement target list to all of the UEs in the current group except the UE that terminates the FD mode participation or the group to which the UE that changes its group currently belongs in consideration of scheduling, available resources, and the like. Such information may be transmitted through the PDCCH or the PDSCH.

When there is no UE that intends to change its group, the eNB may transmit the IDI measurement target list through the PDCCH or the PDSCH in the step S1802. Alternatively, the eNB may assign a bit for indicating the reuse of a previous IDI measurement target list and then transmit the assigned bit through the PDCCH or the PDSCH.

If a UE fails to receive the UE_ID, the IDI measurement target list, or an indicator indicating the reuse of the previous list (for convenience of description, it considered as the IDI measurement target list), the UE may reuse the previous list. In this case, even if the UE fails to receive the UE_ID of the UE that terminates the FD mode participation, the UE does not need to perform the measurement for the UE because the corresponding UE_ID is not included in the measurement list. In addition, in case that the UE fails to receive the list and UE_IDs of UEs added to the grouping, if the UE detects IDI with magnitude greater than a total magnitude of the measured IDI, the UE may inform the eNB of the IDI. Moreover, if the UE fails to receive the IDI measurement target list, the UE may request the eNB to re-transmit the list.

Regarding the UE grasp period, the IDI measurement period, and the group configuration reporting period, which are determined by the eNB, if there is no UE to be changed or if there is no UE to be changed during a prescribed time, the eNB may increase the periods. In this case, the eNB checks whether the group configuration is changed, whether IDI arrangement order of the group is changed, or whether magnitude of specific IDI in the group is decreased below a predetermined value in order to the increase the corresponding periods.

2.3 Interference Measurement

In the steps S1805 and S1807, the eNB may instruct the grouping update target UEs to measure the IDI. After receiving the instruction, the grouping update target UEs may immediately perform the IDI measurement. Alternatively, the eNB may instruct some groups having UEs that terminates the FD mode participation to measure the IDI. When the IDI measurement period is present as shown in the step S1806, the eNB may instruct the IDI measurement. For instance, in case that a measurement period is long and grouping target UEs are not changed frequently, if a grouping target UE needs to be changed, the eNB may instruct the IDI measurement.

In the step S1806, the IDI may be periodically measured using the measurement/reporting periods contained in the information transmitted by the eNB to the UEs in the step S1306 or S1812 or a period configured as a system parameter. A UE may perform the IDI measurement according to the following methods.

As a first method, the UE may perform IDI measurement for all of the UEs by setting a period of time X or TTI (transmit time interval) as the system parameter.

As a second method, the UE may perform IDI measurement for some groups having UEs that terminate the FD mode participation by setting a period of time Y or TTI, which is different from the time X or TTI, as the system parameter. There may be a case in which Y is greater than X depending on the frequency of change in the grouping target UEs.

In addition, the above-mentioned two methods can be simultaneously used and in this case, the load of the IDI measurement may be reduced.

The UE measures the IDI using the frequency assigned for the IDI measurement in the step S1801.

2.4 Grouping Fulfillment and Result Reporting

In the step S1808, the grouping can be performed according to the same method used in the step S134. In addition, the eNB may store a previous group ID assigned to each UE. By doing so, the eNB may know which UE changes its group ID frequently and also perform the following operations.

First, if some of a plurality of group IDs assigned to a single UE are frequently changed, the eNB may know that the corresponding UE is located at a boundary of groups. The IDI value measured by the UE can be utilized as a threshold or the like, which is referenced in the grouping.

Second, if a group ID assigned to a random UE is not repeated during a prescribed time, the eNB may know that the UE is moving. In this case, since the IDI measurement, the grouping, and the group configuration result reporting need to be performed at all time, the eNB may eliminate the corresponding UE from the FD mode by allowing the UE to operate in the fallback mode in order to reduce the number of times of measurement, grouping and reporting.

In the step S1809 and S1811, the eNB may instruct the grouping update target UEs to report information related to the group configuration. After receiving the instruction, the grouping update target UEs may immediately report the group configuration information. The grouping update target UEs may report IDI information measured only in the group in which a grouping result is changed among measuring UEs. Even in case that the reporting period is present as shown in the step S1810, if the eNB instructs some groups having the UEs that terminates the FD mode participation to measure the IDI in the step S1805, UEs in the groups may report the group configuration information according to the instruction from the eNB.

In the step S1810, a UE may periodically report the information of the step S1305 using the measurement/reporting periods received from the eNB in the step S1306 or S1812 or a period configured as a system parameter. The UE may perform the periodic reporting according to the following methods.

As a first method, the UE may perform IDI measurement for all of the UEs by setting a period of time X or TTI (transmit time interval) as the system parameter.

As a second method, the UE may perform IDI measurement for groups having the UEs that terminate the FD mode participation by setting a period of time Y or TTI, which is different from the time X or TTI, as the system parameter. There may be a case in which Y is greater than X depending on the frequency of change in the grouping target UEs.

Additionally, the above-mentioned two methods can be simultaneously used and in this case, the load of the IDI measurement may be reduced.

In the step S1810 or S1811, if magnitude of specific IDI is decreased below a predetermined level or a result of the group configuration is not changed, the UE may not report the grouping information. Instead, the UE may transmit an indicator indicating to refer to previous reporting (through the PUCCH or the PUSCH). In this case, the step S1812 can be omitted. Similar to the step S1305, the UE may transmit information such as the measured IDI value that can be reflected in a later grouping as well as the information indicating whether the UE leads the group configuration and the UE_IDs to the eNB.

If the eNB fails to receive the reporting from the UE during a prescribed time, the eNB may skip the step S1812.

Meanwhile, a UE may refuse the IDI measurement due to the remaining amount of the battery and the like. That is, the corresponding UE may not transmit a signal for identification between UEs and also attempt to receive the signal. In the step S1810 and S1811, the UE may assign a bit indicating that the UE refuses the IDI measurement and then transmit the assigned bit (through the PUCCH or the PUSCH). Alternatively, the UE may not provide any reporting. In addition, while waiting the reporting, the eNB may recognize, though other UEs, that a measured IDI value of a certain UE is significantly decreased. Thereafter, the eNB may know that the UE is the UE that refuses the IDI measurement. In this case, since a measuring UE cannot recognize the corresponding UE, the measuring UE cannot obtain a UE_ID of the UE in spite of performing measurement.

In the step S1812, the eNB may perform the same operation as that in the step S1306.

In step S1813, if there is no more request for the grouping participation, the grouping update is terminated.

Meanwhile, the first embodiment or the second embodiment of the present invention can also be applied to a case in which a UE operates in the FD mode on the same resource.

FIG. 21 illustrates examples in which UEs operate in FD mode on the same resources.

Referring to FIG. 21 (a), since UEs can receive IDI from an eNB, the present invention can be applied by considering the eNB as the UE mentioned in the present invention. In this case, the eNB does not perform a procedure for IDI reporting and transmission of information on a grouping result.

Additionally, the present invention can be also applied to a case in which UEs operate in FD mode on the same resource without data relaying of an eNB, similar to D2D communication of FIG. 21 (b). In the D2D communication, although data transmission through the eNB is not performed, the UEs provide feedback with respect to the eNB for scheduling management at the eNB. Therefore, the procedures described in the present invention can be identically applied.

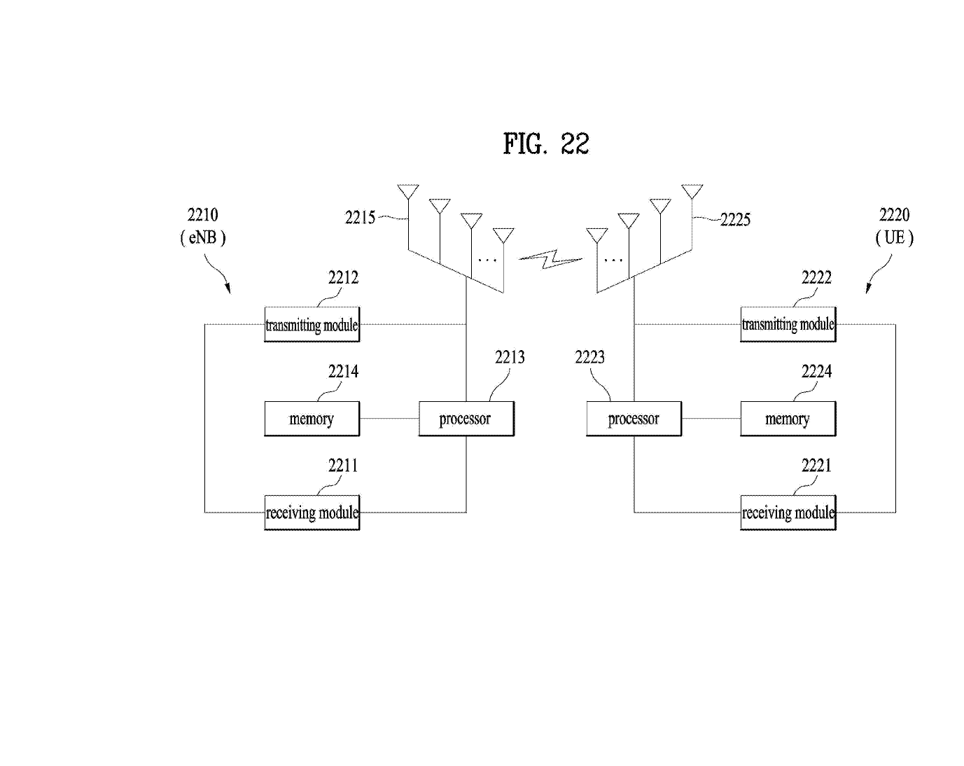

FIG. 22 illustrates an eNB and a UE applicable to an embodiment of the present invention.

If a relay node is included in a wireless communication system, a communication in backhaul link is performed between a base station and the relay node and a communication in access link is performed between the relay node and a user equipment. Therefore, the base station or user equipment shown in the drawing can be substituted with the relay node in some cases.

Referring to FIG. 22, a wireless communication system includes an eNB 2210 and a UE 2220. The eNB 2210 includes a processor 2213, a memory 2214 and an RF (radio frequency) unit 2211 and 2212. The processor 2213 can be configured to implement the procedures and/or methods proposed by the present invention. The memory 2214 is connected to the processor 2213 and stores various kinds of information related to operations of the processor 2213. The RF unit 2216 is connected to the processor 2213 and transmits and/or receives radio or wireless signals. The UE 2220 includes a processor 2223, a memory 2224 and an RF unit 2221 and 2222. The processor 2223 can be configured to implement the procedures and/or methods proposed by the present invention. The memory 2224 is connected to the processor 2223 and stores various kinds of information related to operations of the processor 2223. The RF unit 2221 and 2222 is connected to the processor 2223 and transmits and/or receives radio or wireless signals. The eNB 2210 and/or the UE 2220 can have a single antenna or multiple antennas.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application. In this disclosure, a specific operation explained as performed by a base station can be performed by an upper node of the base station in some cases. In particular, in a network constructed with a plurality of network nodes including a base station, it is apparent that various operations performed for communication with a user equipment can be performed by a base station or other network nodes except the base station. In this case, ‘base station’ can be replaced by such a terminology as a fixed station, a Node B, an eNodeB (eNB), an access point and the like.

Embodiments of the present invention may be implemented using various means. For instance, embodiments of the present invention may be implemented using hardware, firmware, software and/or any combinations thereof. In case of the implementation by hardware, one embodiment of the present invention may be implemented by at least one of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, one embodiment of the present invention may be implemented by modules, procedures, and/or functions for performing the above-explained functions or operations. Software code may be stored in a memory unit and may be then drivable by a processor.

The memory unit may be provided within or outside the processor to exchange data with the processor through the various means known to the public

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. For instance, the respective configurations disclosed in the aforesaid embodiments of the present invention can be used by those skilled in the art in a manner of being combined with one another. Therefore, the present invention is non-limited by the embodiments disclosed herein but intends to give a broadest scope matching the principles and new features disclosed herein.

It will be apparent to those skilled in the art that the present invention may be embodied in other specific forms without departing from the spirit and essential characteristics of the invention. Thus, the above embodiments should be considered in all respects as exemplary and not restrictive. The scope of the present invention should be determined by reasonable interpretation of the appended claims and the present invention covers the modifications and variations of this invention that come within the scope of the appended claims and their equivalents. The present invention is non-limited by the embodiments disclosed herein but intends to give a broadest scope that matches the principles and new features disclosed herein. And, it is apparently understandable that an embodiment is configured by combining claims failing to have relation of explicit citation in the appended claims together or can be included as new claims by amendment after filing an application.

### INDUSTRIAL APPLICABILITY

The present invention can be applied to wireless communication devices such as a UE, a relay, an eNB and the like.

What is claimed is:

1. A method of receiving a signal by a user equipment (UE) in a wireless access system supporting FDR (full duplex radio), the method comprising:
measuring inter-device interference (IDI) between the UE and candidate UEs;
configuring the UE and a candidate UE selected based on measured IDI values as a group;
transmitting group information on the group to an evolved node B (eNB); and
receiving the signal using resources allocated based on the group information.

2. The method of claim 1, wherein configuring the UE and the candidate UE as the group comprises selecting a candidate UE having a measured IDI value equal to or greater than a threshold.

3. The method of claim 2, wherein the resources are allocated such that individual UEs included in the group use different resources and different groups operate in full duplex (FD) mode on the same resources.

4. The method of claim 1, wherein configuring the UE and the candidate UE as the group comprises selecting a candidate UE having a measured IDI value equal to or smaller than a threshold.

5. The method of claim 4, wherein the resources are allocated such that individual UEs included in the group operate in full duplex (FD) mode on the same resources and different groups use different resources.

6. The method of claim 1, further comprising receiving period information on the measurement of the IDI from the eNB.

7. The method of claim 1, further comprising transmitting first information on whether the UE can perform a full duplex (FD) operation on the same resources, second information on whether, although the UE cannot perform the FD operation on the same resources, the UE supports a different device in performing the FD operation, and third information on whether the UE requests to participate in a grouping.

8. A user equipment for receiving a signal in a wireless access system supporting full duplex radio (FDR), comprising:
a radio frequency (RF) unit; and
a processor,
wherein the processor is configured to measure inter-device interference (IDI) between the UE and candidate UEs, configure the UE and a candidate UE selected based on measured IDI values as a group, transmit group information on the group to an evolved node B (eNB), and receive the signal using resources allocated based on the group information.

9. The user equipment of claim 8, wherein the processor is configured to select a candidate UE having a measured IDI value equal to or greater than a threshold.

10. The user equipment of claim 9, wherein the resources are allocated such that individual UEs included in the group use different resources and different groups operate in full duplex (FD) mode on the same resources.

11. The user equipment of claim 8, wherein the processor is configured to select a candidate UE having a measured IDI value equal to or smaller than a threshold.

12. The user equipment of claim 11, wherein the resources are allocated such that individual UEs included in the group operate in full duplex (FD) mode on the same resources and different groups use different resources.

13. The user equipment of claim 8, wherein the processor is configured to receive period information on the measurement of the IDI from the eNB.

14. The user equipment of claim 8, wherein the processor is configured to transmit first information on whether the UE can perform a full duplex (FD) operation on the same resources, second information on whether, although the UE cannot perform the FD operation on the same resources, the UE supports a different device in performing the FD operation, and third information on whether the UE requests to participate in a grouping.
